(19) United States
(12) Patent Application Publication
(10) Pub. No.: US 2009/0073841 A1
(43) Pub. Date: Mar. 19, 2009

(54) METHOD AND APPARATUS FOR RECORDING DATA ONTO AN OPTICAL DISC

(75) Inventors: Donato Pasquariello, Eindhoven (NL); Jan Matthijs Ter Meulen, Eindhoven (NL); Ruud Vlutters, Eindhoven (NL); Rudolf Johan Maria Vullers, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/279,393

(22) PCT Filed: Jan. 29, 2007
(86) PCT No.: PCT/IB07/50293

§ 371 Date: Aug. 14, 2008

(30) Foreign Application Priority Data
Feb. 15, 2006 (EP) 06101702.6

(51) Int. Cl. G11B 20/10

(52) U.S. Cl. 369/59.26; G9B/20.009

(57) ABSTRACT

A method of recording information onto an optical disc of the rewritable type, the disc comprising a spiral track, at least part of the track being arranged as a recording area for recording the information, the recording area being further divided into sequential, independently addressable units of pre-determined size, pre-determined numbers of addressable units being grouped in recording unit blocks comprising: deciding for at least an recording unit block that it will be recorded; determining direct overwrite information for said recording unit block, the direct overwrite information comprising information with respect to the number of times the recording unit block was previously recorded; encoding and recording the information into the recording unit block and updating the direct overwrite information for the recording unit block, the direct overwrite information being recorded within the recording unit block. The method also comprise that before recording, reading the said direct overwrite information and adapting Write Strategy and Write Powers accordingly.

### FIELD OF THE INVENTION

The present invention relates generally to a method of recording information onto an optical disc of the rewritable type. The application also relates to a recording device and an optical disc of the rewritable type.

### BACKGROUND OF THE INVENTION

Rewritable optical media can be overwritten many times. The reversible recording process is based, for example, on the use of an information layer comprising a phase change material that is reversibly changeable between the amorphous and crystalline phase. Amorphous marks are recorded within the crystalline matrix of the information layer, by irradiating the information layer with sequences of short radiation pulses, for example sequences of laser pulses. The radiation pulses melt the phase change material. If the subsequent cooling after turning off the radiation beam is rapid, the amorphous phase is frozen. If the subsequent cooling after turning off the radiation beam is slow, it allows recrystallization and induces a crystalline phase. Consequently such a phase change layer allows information to be recorded and erased by modulating the power of the radiation beam between a write power level and an erase level. The readout is performed by detecting differences in optical properties between the amorphous and crystalline phases of the phase change layer thereby reproducing the recording signals.

It is desirable that the number of times the media can be direct overwritten (DOW) before media degradation takes place is as high as possible. In case of optical discs, several parameters indicative of such as jitter, reflection and modulation often degrades with the number of DOW cycles. This degradation process limits the maximum number of achievable direct overwrites (DOW). The exact reason for this effect is still unknown but several attempts have been made to explain and reduce the influence of optical disc performance on the number of DOW cycles. Moreover, attempting to optimize the DOW properties of an optical disc normally degrades other optical disc parameters.

US patent application No. US2002/0154587 suggests that, for CD-RW media, recorded areas and the number of times each recording area have been recorded to be memorized, either in the memory of the drive or in a predetermined area on the optical disc, the optimal writing power during recording being adapted according to the number of times an recording area has been recorded.

While the solution of US2002/0154587 is applicable to low density and low data speed media such as CD-RW, and wherein the number of recorded areas is expected to be rather small, several problems appear when the solution is intended to applied to high density, high data speed, random overwrite optical media, such as Blu-Ray rewritable (BD-RE) optical discs. For example, rewritable optical discs of the CD type have a storage capacity of up to 900 MB and a data transfer rate of 1.23 Mbit/second for 1× speed, while those of DVD type have a storage capacity of 4.7 GB per layer and a data transfer rate of 11.09 Mbit/second at 1× speed. Blu-Ray (BD) optical discs have a storage capacity of 25 GB per layer and the data transfer rate is 36 Mbit/second at 1× speed. Moreover Blu-Ray disc are random overwrite media, the smallest region that can be recorded corresponding to 64 KB of user data. Storing information with respect to the number of times each recorded area have been recorded in the memory of the drive is not attractive, as such a solution would require a very large memory, leading to an expensive solution. Storing said information in a predetermined area on the optical disc has the drawback that has a strong negative impact on the data transfer rates. It is known that optical disc make use of a contiguous spiral track for recording information, and it is time consuming to seek a certain position on the disc (seek time) and to read information.

### SUMMARY OF THE INVENTION

It is an object of the invention to provide a solution for optimal DOW cyclability that is highly suitable for high density, high transfer data rates optical discs. The object of the invention is reached by a method according to the invention for recording information an optical disc of the rewritable type, the disc comprising a spiral track, at least part of the track being arranged as a recording area for recording the information, the recording area being further divided into sequential, independently addressable units of pre-determined size, pre-determined numbers of addressable units being grouped in recording unit blocks. The method according to the invention comprises steps of deciding for at least a recording unit block that it will be recorded, determining for said recording unit block direct overwrite information comprising information with respect to the number of times the recording unit block was previously recorded, recording the information into the recording unit block and updating the direct overwrite information for the recording unit block, the direct overwrite information being recorded within the recording unit block itself. By recording the direct overwrite information within the recording unit block itself, such information can be easily retrieved on the fly before the writing. Therefore, availability of a large device memory for storing direct overwrite information are removed. Moreover, there is no need to jump to a predefined area on the optical disc to read said information, a time consuming process for linear storage media as optical discs, therefore data transfer rates are improved.

In an advantageous embodiment, the direct overwrite information precedes the information recorded in the recording unit block, thereby allowing recording on the fly, wherein while scanning the optical disc the direct overwrite information is read and the recording strategy being adapted accordingly. In a preferred embodiment of the method, each recording unit block comprising a data block comprising the information, and a run-in block for linking, the run-in block preceding the data block, the direct overwrite information being recorded in the run-in block. For facilitating readout, the run-in block may comprise a synchronization sequence preceding the direct overwrite information.

When two neighboring recording unit blocks are written in different sessions a certain overlap between the two may take place, therefore part of the information available in the run-in block may be lost after recording information in a succeeding recording unit block. Consequently, in order to avoid such losses, in an advantageous embodiment, a guard unit succeeds a sequence of contiguously recorded recording unit blocks, the guard unit comprising direct overwrite information with respect to the number of times a succeeding recording unit block has been recorded. The reliability can be further improved by the direct overwrite information further comprises information with respect to the number of times a preceding recording unit block has been recorded. Preferably, the guard unit further comprises direct overwrite information with respect to the number of times a last recording unit block from the sequence of contiguously recorded recording unit blocks has been recorded.

In an advantageous embodiment, the write parameters and/or the write strategy for recording the recording unit block are adapted according to the determined direct overwrite information. It has been discovered by the inventors that adapting not only the write power, but also other write parameters such as erase power and/or pulse shape further improves the DOW cyclability.

In an embodiment of the method, the optical disc is further provided with recording information with respect to write parameters and/or write strategy to be used for a number of direct overwrites, the method further comprising reading said recording information and adapting the write parameters and/or the write strategy for recording the recording unit block according to the determined direct overwrite information and said recording information. This allows that optimum write parameters and/or the write strategy for the number of direct overwrites to be indicated by the disc manufacturer.

### BRIEF DESCRIPTION OF THE DRAWINGS

The features and advantages of the invention will be appreciated upon reference to the following drawings, in which:

FIG. 1 illustrates schematically a block diagram of a recording device wherein the invention may be practiced;

FIG. 2 illustrates schematically an optical disc according to the invention;

FIG. 3 illustrates the schematically the structure of a recording unit block according to an embodiment of the invention;

FIG. 4 illustrates a method of recording according to two embodiments of the invention;

FIG. 5 illustrates the measured jitter as function of the number of direct overwrites for two different write strategies and recording powers;

FIG. 6 illustrates the reflectivity as function of the number of direct overwrites for different erase powers;

FIG. 7 illustrates the measured jitter as function as the number of direct overwrites for different erase powers.

### DETAILED DESCRIPTION OF THE PREFERRED EMBODIMENTS

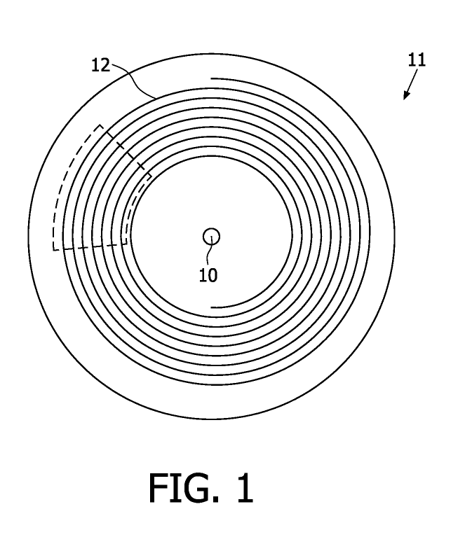

A block diagram of a recording device wherein the invention may be practiced is shown in FIG. 1. Such recording device is used for writing information on an optical disc 11 of a rewritable type, for example CD-RW, or DVD+RW or BD-RE. The device is provided with recording means for scanning a track of the optical disc 11, the recording means comprising a drive unit 21 for rotating the optical disc 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the optical disc. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element.

For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators.

For recording information, the radiation beam 24 is controlled to create optically detectable marks in the recording layer. For this purpose, the device comprises write processing means for processing input information to generate a write signal to drive the head 22, which write processing means comprise an input unit 27, and data processing means comprising a formatter 28 and a modulator 29.

The control unit 20 controls the recording and retrieving of information and may be arranged for receiving commands from a user or from a host computer. To this end, the control unit 20 may comprise control circuitry, for example a microprocessor, a program memory and control gates, for performing the procedures described below. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor or a digital signal processor, a program memory and control gates, for performing the procedures and functions according to the invention as described below. The control unit 20 may also be implemented as a state machine in logic circuits, for example by means of suitable firmware running on a general purpose processor.

The input unit 27 receives and pre-processes the user information. For example, when processing audio-video information, the input unit 27, may comprise for example compression means for input signals such as analog audio and/or video, or digital uncompressed audio/video. Suitable compression means are described for audio in WO 98/16014-A1 (PHN 16452), and for video in the MPEG2 standard. The input signal may alternatively be already encoded. The output of the input unit 27 is passed to the formatter 28 for adding control data and formatting the data according to a recording format, e.g. by adding error correction codes (ECC) and/or interleaving. For computer applications, units of information may be interfaced to the formatter 28 directly. The formatted data from the output of the formatter 28 is passed to the modulation unit 29, which comprises for example a channel coder, for generating a modulated signal, which drives the head 22. Further, the modulation unit 29 comprises synchronizing means for including synchronizing patterns in the modulated signal. The formatted units presented to the input of the modulation unit 29 comprise address information and are written to corresponding addressable locations on the optical disc under the control of control unit 20. The control unit 20 is arranged for recording and retrieving position data indicative of the position of the recorded information volumes.

During the writing operation, marks representing the information are formed on the optical disc. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. Writing and reading of information for recording on optical disks and usable formatting, error correcting and channel coding rules are well-known in the art, e.g. from the CD system.

For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by a read processing unit, comprising a demodulator 271 for de-modulating the modulated signal, e.g. by channel decoding, a de-formatter 281 for extracting the information and an output unit 291 for outputting said information. Hence, retrieving means for reading information include the drive unit 21, the head 22, the positioning unit 25 and the read processing unit 30.

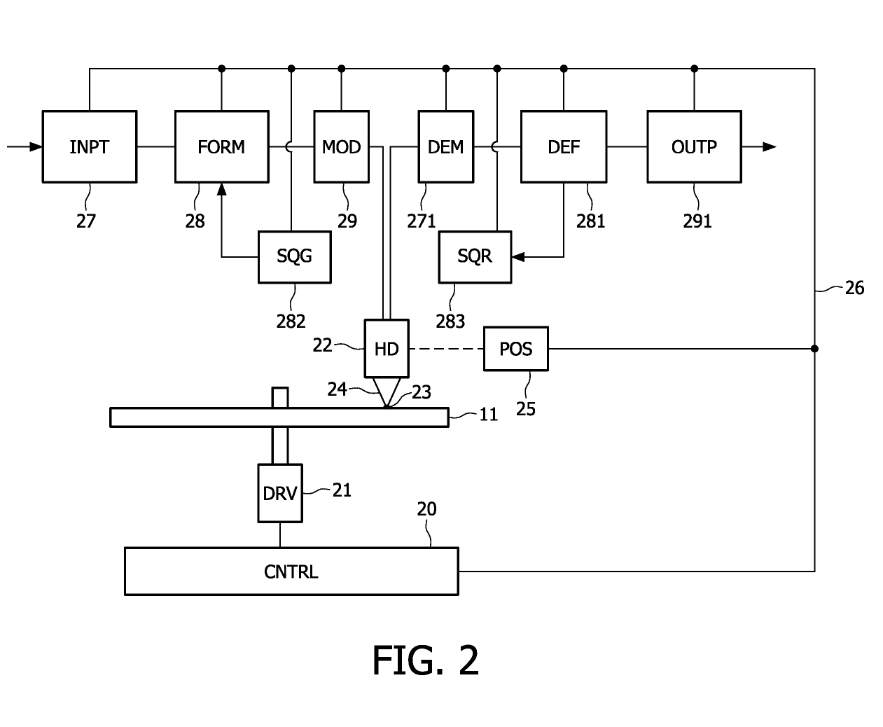

FIG. 2 illustrates schematically an optical disc 11 according to the invention having a track 9 and a central hole 10. The track 9, being the position of the series of (to be) recorded marks representing information, is arranged in accordance with a single spiral pattern constituting substantially parallel tracks on an information layer. The optical disc may comprise one or more information layers of a rewritable type. Examples of a rewritable optical disc are the CD-RW, rewritable versions of DVD, such as DVD+RW or DVD-RW, and the high-density rewritable optical disc using blue lasers, called Rewritable Blu-Ray Disc (BD-RE). For example, further details about the physical structure and addressing information for DVD+(−)RW optical disc can be found in references ECMA-337 and ECMA 338, respectively. The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pre-groove which enables a read/write head to follow the track during scanning. The track structure comprises position information, e.g. addresses, for indication the location of units of information, usually called information blocks. The position information includes specific synchronizing marks for locating the start of such information blocks. The position information is encoded in frames of modulated wobbles.

The record carrier 11 is intended for carrying real-time information according to a standardized format, to be playable on standardized playback devices. The recording format includes the way information is recorded, encoded and logically mapped. The logical mapping may comprise a subdivision of the available area in a lead-in, a recording area for recording user data and a lead-out. Further, the mapping may comprise file management information for retrieving the user information, such as a Table Of Contents or a file system, such as ISO 9660 for CD or UDF for DVD. Such file management information is mapped on a predefined location on the record carrier, usually in or directly after the lead-in area. However, this application relates to recording user data in the recording area.

For example, in case of BD-RE discs, the information onto the optical disc is in general organized in 64 KB Physical Clusters, each Cluster further comprising 32 Physical Sectors, each containing 2K of data. For positioning the optical head onto the desired track, a fast addressing mechanism is implemented by subdividing the 64K Physical Clusters into 16 Address Units. An Address Unit is the smallest unit that can be individually addressed. The unit of recording is a Recording Unit Block (RUB), consisting of a Physical Cluster preceded by a Data Run-in and followed by a Data Run-out. The Run-in and Run-out are used for buffering for facilitating fully random write/overwrite. Recording Unit Blocks can be written one-by-one or in a continuous sequence of several RUBs (write_streaming).

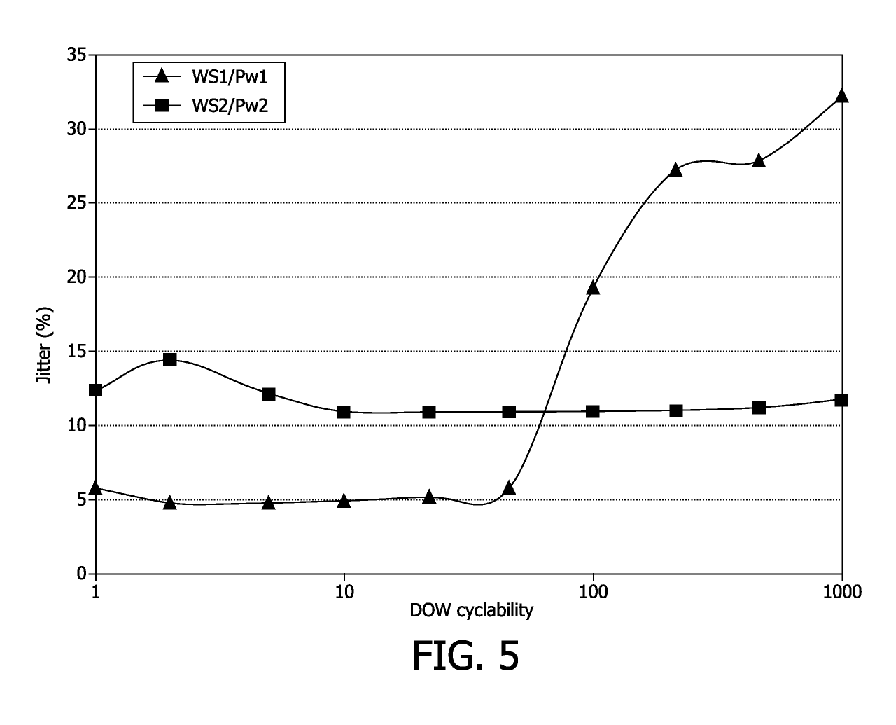

However this document further relates to the issue of improving DOW cyclability. As it will be detailed below with respect to FIG. 5-8, several parameters indicative of such as jitter, reflection and modulation often degrades with the number of DOW cycles. This degradation process limits the maximum number of achievable direct overwrites (DOW). Adapting the write strategy parameters according to the DOW number increases the number of DOW cycles. Rewritable optical discs such as BD-RE and DVD+RW allows random write, i.e. data packets can be written at random locations of the disc, allowing some (empty) space between the recently written areas. The data packet sizes can be very small, e.g. a series of digital photo files. When sequential overwriting a long file it may happen that different clusters have different history which mean that the drive would have to change the write strategy during overwrite.

For example, in the case of BD-RE optical discs, the smallest size that can be recorded on disc corresponds to 64 KB, while the total capacity of the disc is 25 GB. A solution to improving DOW cyclability is to provide a DOW management data, wherein information with respect to each DOW number is maintained for each RUB. For example, before a packet is written, a counter on the disc (that keeps track on the DOW) is updated. Next time this packet is being written, the recorder first read the counter and then the optimized Write Strategy/Write Power for the specific DOW cycle is used to write the data on that section of the disc.

However, a separate area for management wherein DOW information is stored is not practical, as it would require memory large size if to be loaded in memory in order to provide maximal recording speed, while attempting to read this information before recording each 64K Recording Unit Blocks is not possible as this would reduce the recording speed, due to large seek times.

The gist of our invention is to introduce a DOW counter on the disc that is present in each data block, for example in the case of BD-RE in each Recording Unit Block, or in the case of DVD+RW in each Physical Cluster. Preferably, the optical disc carries information about what Write-Strategy and Write-Powers to use at different DOW cycles. Using this information the optimal Write Strategy/Write Power is used depending on the type of optical disc and on the number of DOW cycles for a given data block.

In the following a detailed description will be provided with respect to an exemplary embodiment with respect to BD-RE discs.

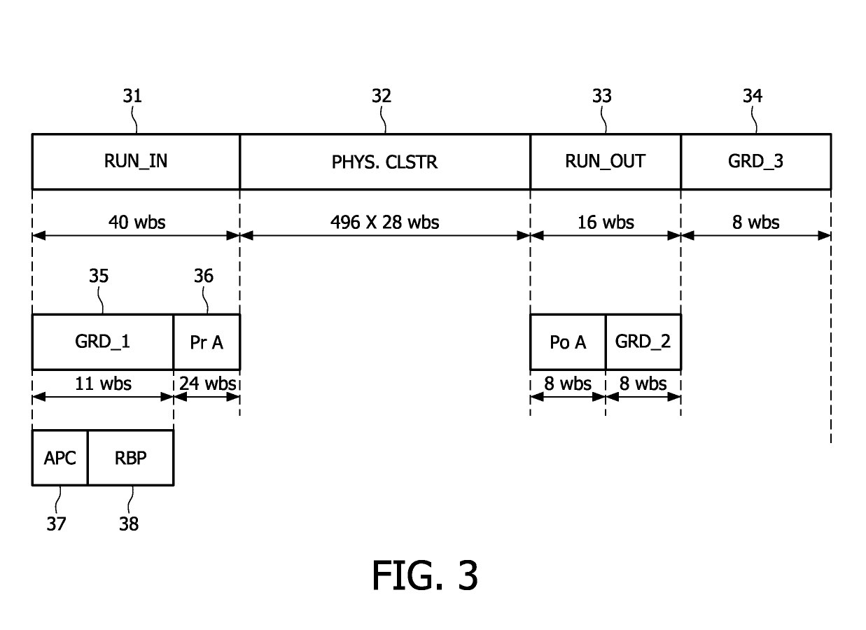

FIG. 3 schematically illustrates the structure of a recording unit block according to an embodiment of the invention. The unit of recording is a Recording Unit Block (RUB), consisting of a Physical Cluster 32 preceded by a Data Run-in 31 and followed by a Data Run-out 33. The Run-in 31 and Run-out 32 are offering sufficient buffering for facilitating fully random write/overwrite. Recording Unit Blocks can be written one-by-one or in a continuous sequence of several RUBs (write streaming). In the rewritable areas of the disc, a wobble cycle corresponds to 69 channel bits if the Channel bit rate is locked to the wobble frequency. This means that a modulated Recording Frame, which is 1932 channel bits (−1288 data bits), covers exactly 28 wobble cycles.

Each single written RUB or each continuously written sequence of RUBs is terminated by a Guard_3 field 34, ensuring that no gaps (unrecorded areas) will ever occur between any two RUBs. Such a Guard_3 field corresponds to≈8 wobble periods). If defective areas are encountered during writing of a continuous sequence, then this sequence can be broken up into several parts, where each part is terminated by a Guard_3 field.

The Run-in 31 has a length of approx. 40 wobbles and it consists of a Guard_1 35 and a preamble part (PrA) 36, while the Run-out consists of a post-amble part (PoA) and Guard_2 field,

The Guard_1 35 field comprises an optional area for power calibration (APC) 37 having a length of 5 wobble cycles and a repeated bit pattern (RPB) 38 for synchronization purposes having a length of 11 wobble cycles. The Guard_3 field 34 comprises a repeated bit pattern for synchronization purposes corresponding to 3 wobble cycles and an optional area for power calibration corresponding to 5 wobble cycles.

The optional power calibration area in Guard_1 and Guard_3, each having a length of 5 wobbles (345 cbs) are used for storing the information of the number of overwrites (DOW).

By default, the Guard_1 and Guard_3 are filled for example with a repetition pattern consisting of 20 channel bits: 3T/3T/2T/2T/5T/5T. In order to record the DOW information, a region corresponding to 5 wobbles or 345 channel bits (cbs) is available. For reason of DC control, the following solution is chosen:

a Guard_1 field 31 according to the invention comprises 1100 cbs in total, wherein 340 cbs are used for recording the DOW number information, followed by 760 cbs filled with a default pattern, for example the pattern 3T/3T/2T/2T/5T/5T is repeated 38 times.

a Guard_3 field 34 according to the invention: comprises 540 cbs in total, wherein 200 cbs are filled with a default pattern, for example the pattern 3T/3T/2T/2T/5T/5T repeated 10 times, followed by 340 cbs used for storing the DOW number information.

In the above embodiment, there are 340 cbs available for storing the DOW number information. Optionally, in order to indicate that there is something special inside, the actual information may be preceded a sync pattern, for example corresponding to 30 cbs. If this option is used, 280 cbs remain for storing the actual DOW number.

A DOW number in data bit representation can consist of 7 groups of 4 bits each:

Bit 1 to 4: defining a number between 0 and 9 Bit 5 to 8: defining the 10¹ digit, between 0 and 9

. . .

Bit 25 to 28: defining the 10⁶ digit, between 0 and 9

So for example,

1001 1001 0011 0000 0000 0000 0000 means DOW=0000399

0011 0010 0000 0110 0000 0000 0000 means DOW=0006023

These bits may be converted to modulation bits prior to recording on disc. For example, if 17 ppm modulation is used as described in U.S. Pat. No. 6,496,541 (PHQ98023), recording the DOW number requires 28*3/2=42 cbs. If error correction and DC control are used for improved reliability, 54 cbs are required for storing the DOW number. Consequently, for improving reliability, this information can be repeated 5 times, to fill the 280 cbs.

In case one records the values of two RUBs, for both the current and the preceding unit, at least 84 cbs. Adding 56 cbs for error correction and dc control, we will end up with 140 cbs. This pattern can be repeated twice.

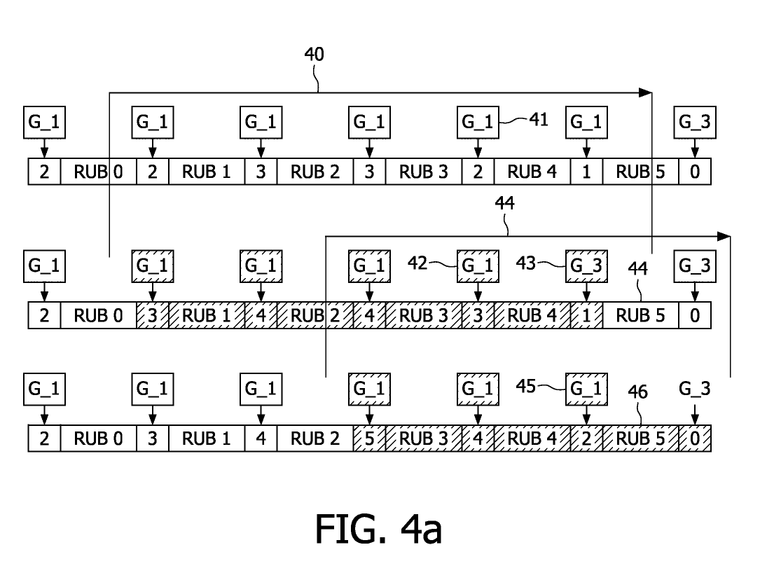

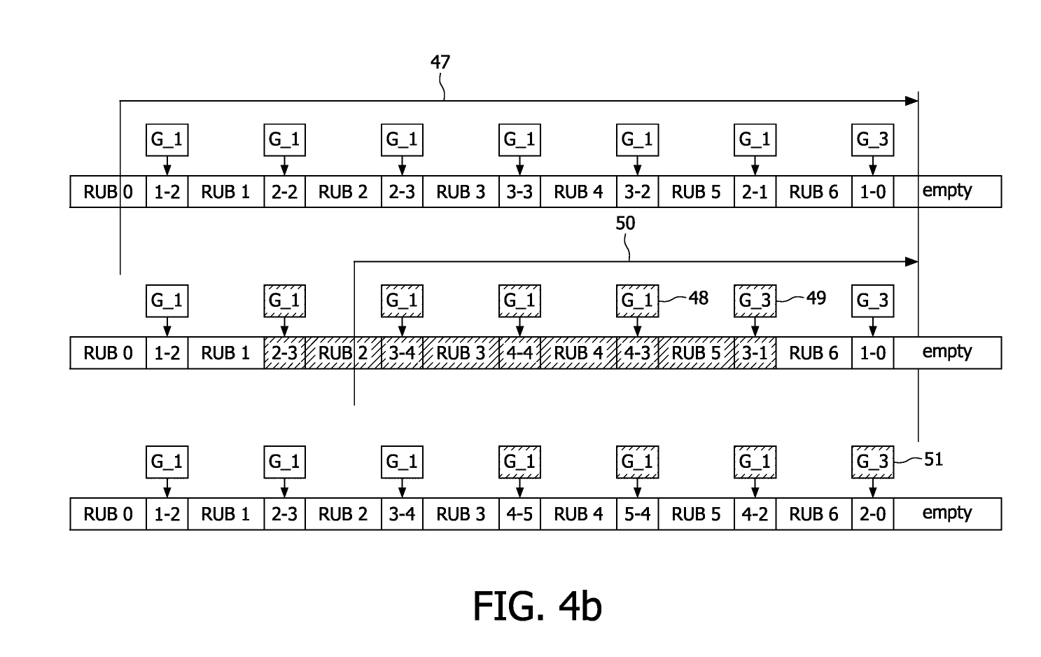

FIGS. 4a and b illustrates a method of recording according to two embodiments of the invention;

When two neighboring RUBs are written in different sessions, the run-in area 31 and the Run-out/Guard_3 areas may overlap. The total overlap may extend between 3 and 13 wobbles. Since the DOW number information in Guard_1 field 35 and the DOW number information in Guard_3 field 34 are located in the first 5 or the last 5 wobbles of an RUB, the information stored in this area may be lost after overwrite. Therefore, the information about DOW might not be available after overwrite of neighboring tracks. To address this issue, the following solutions were found:

When (over)writing a certain number of RUBs, from address 1 to address N, first all RUBs from address 0 to N+1 are read, so that always the information in the Guard_3 of address 0 or Guard_1 of address 1 can be read. The same applies for information of Guard_3 of address N or Guard_1 of address N+1.

Optionally, in an embodiment, all DOW information of all addresses are stored in an internal memory, which is used to write the new DOW value while writing a particular Physical cluster. If the available internal memory is not big enough to store all information of all clusters to be written, the writing task may be divided in subtasks.

FIG. 4a illustrates an example of write and read strategy in case the Guard areas comprises one DOW number corresponding to the current RUB. G_1 labels indicate the Guard_1 field, while RUB indicates a recording unit block. The number inside a Guard_1 field indicated the DOW number value. The first line indicated the status of a region of the recording area, while the arrow 40 indicates the region to be read. In the next line, the status after recording is indicated. The hashed regions are newly recorded, and the Guard areas are updated with the new DOW number. for example, the guard 1 field 41 of RUB4 was indicative the RUB4 has been recorded twice and the new guard 1 field 42 is indicative that RUB4 has been recorded three times. The recording ends with a Guard_3 field 43, indicative of the DOW number of a succeeding RUB. The arrow 44 indicates again a second read/record process. For example, in the third line the information in the old guard_3 field 43 is now updated and present in the Guard_1 field 45 corresponding to RUB 5.

FIG. 4b illustrates an example of write and read strategy in case the Guard fields comprises two DOW numbers, corresponding to the current and preceding RUBs. G_1 labels indicate the Guard_1 field, while RUB indicates a recording unit block. The number inside a Guard_1 field indicated the DOW number value for preceding and succeeding RUBs, respectively. Top: The arrow 47 and respectively 50 indicates the region to be read/recorded. In the next line, the hashed regions correspond to newly recorded regions. For example, guard_3 field 49 ending the recording step indicated the DOW value for the preceding and succeeding RUBs. The Guard fields are to be updated with the new DOW number. Note that compared to the method as disclosed with respect to FIG. 4a, one more Guard field needs to be read/updated.

With respect to implementation in a recording device as described with respect to FIG. 1, in an embodiment of the invention, sequence generation means (282), under the control of the control unit 20, can be present for receiving DOW number information from the control unit 20 and for instructing the formatting means 28 to adapt the Guard units as described above. Sequence readout means 283 can be used to receive the data stream generated by the deformatter 281, extract the DOW number information and supply said DOW number information to the control unit 20. It should be note that the function of the sequence generation means 282 and the sequence readout means can also be implanted in the control unit 20 by means of suitable hardware or firmware. It is understood that sequence readout means 283 may be comprised in the retrieving means and the sequence generation means 282 may be comprised in the recording means.

As it will be detailed below with respect to FIG. 5-8, several parameters indicative of such as jitter, reflection and modulation often degrades with the number of DOW cycles.

FIG. 5 illustrates the measured jitter as function of the number of direct overwrites for two different write strategies and recording powers in the case of a BD-RE discs. The inventors have observed that the DOW performance of such a BD-RE disc is very dependent on the chosen write-strategy, the write, erase and background power levels and on the layer stack. In the measurement the inventors have performed, a tendency was found that write strategies, write powers and layer stacks that gives good results at low number of DOW cycles often perform worse at high DOW cycles, and the other way around. FIG. 1 shows the jitter as a function of DOW cycles for two different write strategies/power levels for a Blu-Ray discs. For this specific example, the first write strategy/power level corresponded to wider pulses of 4 ns, a write power of 8 mW and an erase power of 3 mW, while the second write strategy corresponded to narrower pulse of 3.75 ns, a write power of 4 mW and an erase power of 4 mW.

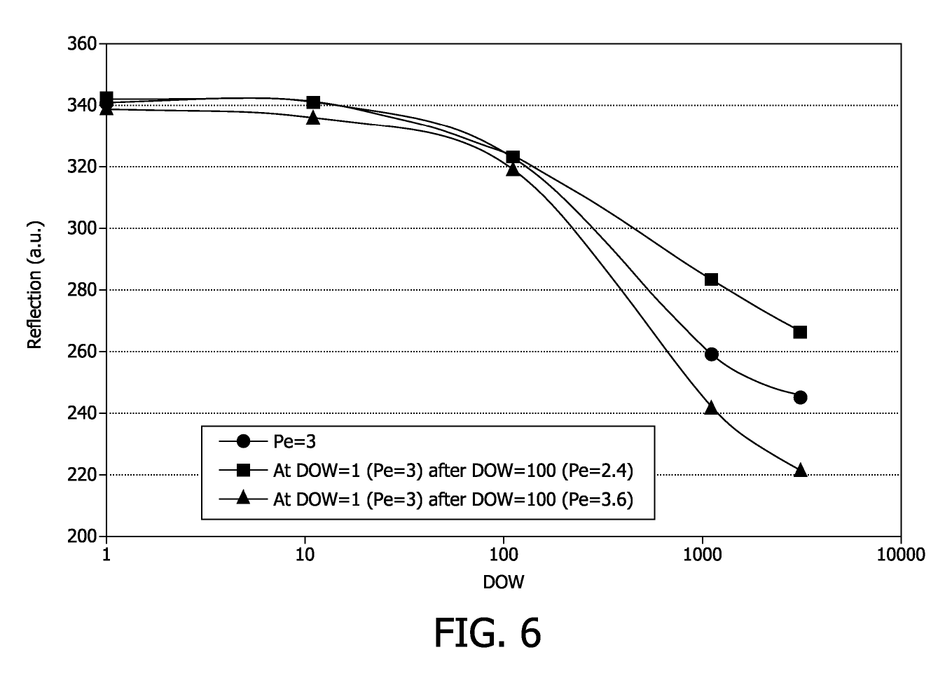

FIG. 6 illustrates the reflectivity as function as the number of direct overwrites for different erase powers in the case of BD-RE discs. A change in reflectivity is normally indicative of disc degradation. The inventors have discovered that not only the write power is important in determining the DOW cyclability, but other parameters, such as the erase power are also important. It was identified that reflectivity decrease was reduced when at DOW=100 the erase powers was reduced and that the reflectivity decreased faster when the erase power was increased at DOW=100.

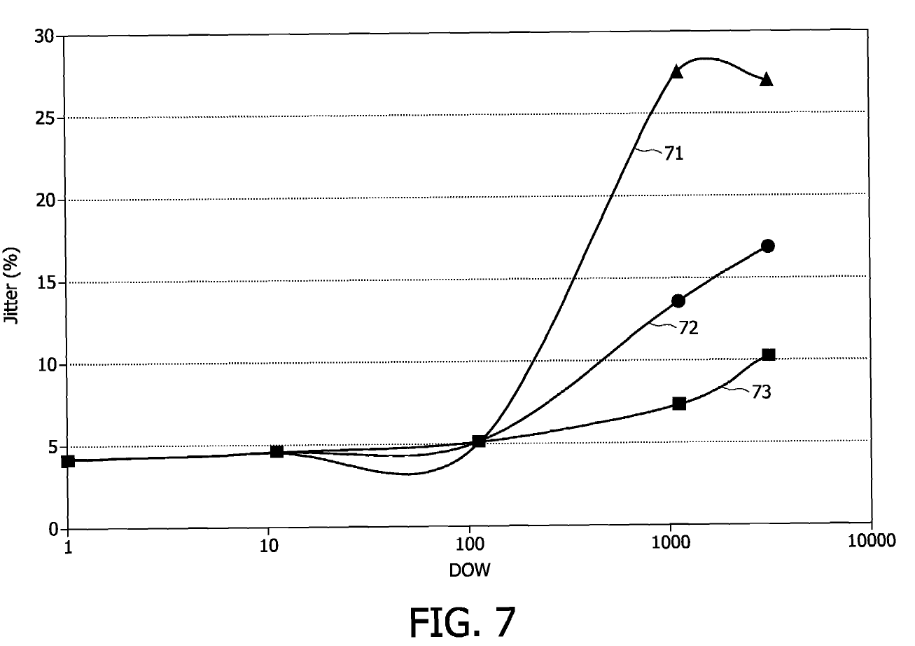

FIG. 7 illustrates the measured jitter as function as the number of direct overwrites for different erase powers (same parameters as in FIG. 6) in the case of a BD-RE discs. It can be concluded that the recording quality improves when the Erase Power is changed to 2.4 mW after 100 DOW cycles and is reduced when the Erase Power is changed to 3.6 mW after 100 DOW cycles.

It should be note that the inventors also found out that the optimum write power depends on the DOW number. Therefore, in order to improve cyclability, it is advantageous that, depending on the number of DOW cycles, the optimal write strategy and recording powers (e.g. write, erase) are used. Thereby, a method of recording can be chose that allows an optimal recording both for low number of DOW cycles and high number of DOW cycles.

In an advantageous embodiment, the disc manufactures may pre-record on disc recording information with respect to the optimal Write Strategy and Powers (e.g. write, erase) to be used for a given number of DOW cycles. Such information can be recorded for example in a pre-defined region on disc, for example in the lead-in area. A recording device according to the invention prior to recording reads such recording information and adapts the write strategy and recording powers for each recording unit block (RUB) according to the recording information and the DOW number information present in each RUB. Optionally, the recording information may be read when the disc is inserted in the device and stored in a memory.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable firmware. Firmware may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measured cannot be used to advantage.

1. A method of recording information onto an optical disc of the rewritable type, the disc comprising a spiral track, at least part of the track being arranged as a recording area for recording the information, the recording area being further divided into sequential, independently addressable units of pre-determined size, pre-determined numbers of addressable units being grouped in recording unit blocks,
the method comprising:
deciding for at least one recording unit block that it will be recorded;
determining direct overwrite information for said recording unit block, the direct overwrite information indicative of a number of times the recording unit block has been previously recorded;
encoding and recording the information into the recording unit block
the method characterized by further comprising:
updating the direct overwrite information for the recording unit block, the direct overwrite information being recorded within the recording unit block.

2. A method according to claim 1, characterized by the direct overwrite information preceding the information recorded in the recording unit block.

3. A method according to claim 2, characterized by each recording unit block comprising a data block comprising the information, and a run-in block for linking, the run-in block preceding the data block, the direct overwrite information being recorded in the run-in block.

4. A method according to claim 3, characterized by the run-in block comprising a synchronization sequence preceding the direct overwrite information.

5. A method according to 2, characterized by direct overwrite information is further indicative of a number of times a preceding recording unit block has been recorded.

6. A method according to claim 1, characterized by recording a guard unit succeeding a sequence of contiguously recorded recording unit blocks, the guard unit comprising direct overwrite information indicative of a number of times a succeeding recording unit block has been recorded.

7. A method according to claim 6, characterized by the guard unit comprising direct overwrite information indicative of a number of times a last recording unit block from the sequence of contiguously recorded recording unit blocks has been recorded.

8. A method according to claim 2, characterized by adapting the write parameters and/or the write strategy for recording the recording unit block according to the determined direct overwrite information.

9. A method according to claim 8, wherein the optical disc is further provided with recording information with respect to write parameters and/or write strategy to be used for a number of direct overwrites, the method further comprising:
reading said recording information and adapting write parameters and/or write strategy for recording the recording unit block according to the determined direct overwrite information and said recording information.

10. A recording device for recording information onto an optical disc of the rewritable type, the disc comprising a spiral track, at least part of the track being arranged as a recording area for recording the information, the recording area being further divided into sequential, independently addressable units of pre-determined size, pre-determined numbers of addressable units being grouped in recording unit blocks,
the recording device comprising:
recording means for recording information onto the optical disc;
retrieving means for reading information from the optical disc;
a control unit for controlling the recording means and the retrieving means, the control unit being adapted
to enable the retrieving means to determine direct overwrite information for a recording unit block to be recorded, the direct overwrite information indicative of a number of times the recording unit block has been previously recorded;
to enable the recording means to encode and record the information into the recording unit block;
to enable the recording means to update the direct overwrite information for the recording unit block,
the control unit being further adapted to enable the retrieving means to read direct overwrite information stored in the recording unit block and to enable the recording means to record the direct overwrite information in the recording unit block.

11. A recording device according to claim 10, characterized in that the direct overwrite information precedes the information recorded in the recording unit block.

12. A recording device according to claim 11, characterized in that each recording unit block comprises a data block comprising the information, and a run-in block for linking, the run-in block preceding the data block, the retrieving means being enabled to read direct overwrite information stored in the run-in block and the recording means being enabled to record the direct overwrite information in the run-in block.

13. A recording device according to claim 12, characterized in that the run-in block comprises a synchronization sequence preceding the direct overwrite information.

14. A recording device according to claim 11, characterized in that the direct overwrite information is further indicative of a number of times a preceding recording unit block has been recorded.

15. A recording device according to claim 10, characterized in that the recording means are enabled to recording a guard unit succeeding a sequence of contiguously recorded recording unit blocks, the guard unit comprising direct overwrite information indicative of a number of times a succeeding recording unit block has been recorded.

16. A recording device according to claim 15, characterized in that the guard unit comprising direct overwrite information indicative of a number of times a last recording unit block from the sequence of contiguously recorded recording unit blocks has been recorded.

17. A recording device according to claim 11, characterized in that the recording means are enabled to adapting the write parameters and/or the write strategy for recording the recording unit block according to the determined direct overwrite information.

18. A method according to claim 17, wherein the optical disc is further provided with recording information with respect to write parameters and/or write strategy to be used for a number of direct overwrites, the retrieving means being further enabled to reading said recording information and adapting write parameters and/or a write strategy for recording the recording unit block according to the determined direct overwrite information and said recording information.

19. An optical disc of the rewritable type, the disc comprising a spiral track, at least part of the track being arranged as a recording area for recording the information, the recording area being further divided into sequential, independently addressable units of pre-determined size, pre-determined numbers of addressable units being grouped in recording unit blocks,
characterized in that at least a recording unit block is provided with direct overwrite information with respect to a number of times the recording unit block has been recorded, the optical disc being further provided with recording information with respect to write parameters and/or write strategy to be used for a number of direct overwrites.
